(19) United States
(12) Patent Application Publication
(10) Pub. No.: US 2018/0314626 A1
(43) Pub. Date: Nov. 1, 2018

(54) STORAGE DEVICE, CONTROL METHOD AND ACCESS SYSTEM

(71) Applicant: Silicon Motion, Inc., Jhubei City (TW)

(72) Inventor: Bor-Woei KUO, Kaohsiung City (TW)

(21) Appl. No.: 15/863,891

(22) Filed: Jan. 6, 2018

(30) Foreign Application Priority Data
Apr. 28, 2017 (TW) 106114262

(51) Int. Cl. G06F 12/02

(52) U.S. Cl. CPC G06F 12/023; G06F 2212/205; G06F 2212/251

(57) ABSTRACT

A storage device coupled to a host device and including a volatile memory, a non-volatile memory, a controller and a reverser is provided. The controller accesses the volatile memory and the non-volatile memory. The reverser reverses the sequence of the arrangement of the values of input data to generate output data. The controller provides the output data to the host device or stores the output data in the non-volatile memory.

### CROSS REFERENCE TO RELATED APPLICATIONS

This Application claims priority of Taiwan Patent Application No. 106114262, filed on April 28, 2017, the entirety of which is incorporated by reference herein.

### BACKGROUND OF THE INVENTION

### Field of the Invention

The invention relates to an electronic device, and more particularly to a storage device.

### Description of the Related Art

Storage devices configured to store data are common electronic devices. Storage devices are classified into volatile memories and non-volatile memories. The most common volatile memories comprise dynamic random-access memories (DRAMs) and static random-access memories (SRAMs). The non-volatile memories comprise read-only memories (ROMs), programmable ROMs (PROMs), erasable PROMs (EPROMs), electrically EPROMs (EEPROMs) and flash memories.

### BRIEF SUMMARY OF THE INVENTION

In accordance with an embodiment, a storage device is coupled to a host device and comprises a volatile memory, a non-volatile memory, a controller and a reverser. The controller accesses the volatile memory and the non-volatile memory. The reverser reverses a sequence of an arrangement of values of input data to generate output data. The controller provides the output data to the host device or stores the output data in the non-volatile memory.

A control method for a storage device is provided. An exemplary embodiment of a control method for a storage device is described in the following paragraph. An external command is received. The type of the external command is determined. The sequence of the arrangement of the values of input data is reversed to generate output data when the external command matches a specific protocol. The output data is provided to a host device or stored.

In accordance with another embodiment, an accessing system comprises a host device and a storage device. The host device provides an external command. The storage device receives the external command and comprises a volatile memory, a non-volatile memory, a controller and a reverser. The controller accesses the volatile memory and the non-volatile memory. The reverser reverses the sequence of the arrangement of the values of input data to generate output data. The controller outputs the output data to the host device or stores the output data in the non-volatile memory.

Methods controlling a storage device may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes an apparatus for practicing the disclosed method.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an accessing system, according to various aspects of the present disclosure.

FIG. 2A shows the relationship between input data and output data, according to various aspects of the present disclosure.

FIG. 2B shows another relationship between input data and output data, according to various aspects of the present disclosure.

FIG. 3 is a schematic diagram of an exemplary embodiment of a storage device, according to various aspects of the present disclosure.

FIG. 4 is a schematic diagram of another exemplary embodiment of the storage device, according to various aspects of the present disclosure.

FIG. 5 is a flowchart diagram of an exemplary embodiment of a control method, according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

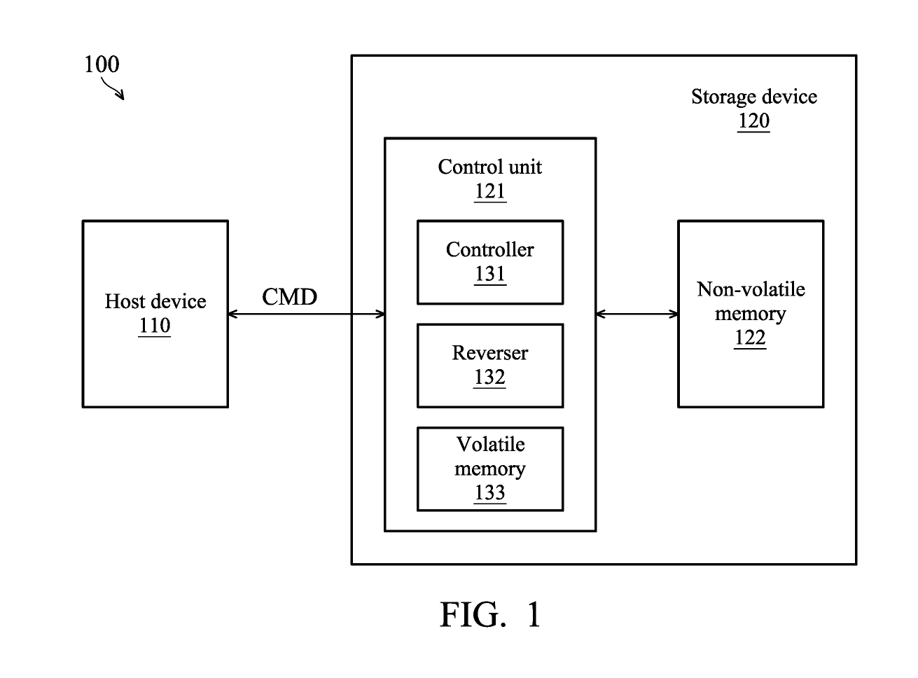

FIG. 1 is a schematic diagram of an exemplary embodiment of an accessing system, according to various aspects of the present disclosure. The accessing system 100 comprises a host device 110 and a storage device 120. The host device 110 outputs a command CMD to access the storage device 120. The storage device 120 executes a corresponding operation according to the type of the command CMD. For example, when the command CMD is a write command, the storage device 120 enters a write mode to store the data provided from the host device 110. When the command CMD is a read command, the storage device 120 enters a read mode to provide data to the host device 110. In other embodiments, when the command CMD is a set command, the storage device 120 enters a set mode to set the values stored in registers disposed in the storage device 120. In the present disclosure, the type of the storage device 120 is not limited. In one embodiment, the storage device 120 matches a universal flash storage (UFS) protocol.

As shown in FIG. 1, the storage device 120 comprises a control unit 121 and a non-volatile memory 122. The control unit 121 accesses the non-volatile memory 122 according to the command CMD. For example, during a write mode, the control unit 121 writes external data provided from the host device 110 into the non-volatile memory 122. During a read mode, the control unit 121 reads the non-volatile memory 122 to generate read data and then provides the read data to the host device 110. Furthermore, the control unit 121 also sets or resets the non-volatile memory 122 according to the command CMD.

In this embodiment, the control unit 121 comprises a controller 131, a reverser 132 and a volatile memory 133. The controller 131 controls the reverser 132, the volatile memory 133 and the non-volatile memory 122 according to the command CMD. For example, when the command CMD is a write command, the controller 131 enters a write mode. During the write mode, the controller 131 receives external data provided form the host device 110. In this case, the controller 131 temporarily stores the external data in the volatile memory 133 and then transmits the external data stored in the volatile memory 133 to the non-volatile memory 122. Similarly, when the command CMD is a read command, the controller 131 enters a read mode. During the read mode, the controller 131 reads specific data stored in the non-volatile memory 122 and serves the specific data as read data. The controller 131 temporarily stores the read data in the volatile memory 133 and then outputs the read data stored in the volatile memory 133 to the host device 110.

In this embodiment, the controller 131 comprises a program code to determine whether the command CMD matches a specific protocol. In one embodiment, the specific protocol is a replay protected memory block (RPMB) protocol. When the command CMD does not match the RPMB protocol, the controller 131 accesses the non-volatile memory 122 according to the type of the command CMD (e.g. a write command, a read command, a set command or a reset command). Taking the write command as an example, when the host device 110 provides external data, the controller 131 does not change the sequence of the arrangement of the values of the external data. In this case, the controller 131 sequentially stores the values of the external data to the volatile memory 133 according to the original sequence of the arrangement of the values of the external data. For example, the controller 131 may first store the external data to the volatile memory 133 and then transmit the external data stored in the volatile memory 133 to the non-volatile memory 122.

However, when the command CMD matches the RPMB protocol, the controller 131 triggers the reverser 132 to change the sequence of the arrangement of the values of input data and then provides the changed sequence of the arrangement of the values of the input data to the host device 110 or the non-volatile memory 122 according to the type of the command CMD. The invention does not limit how the controller 131 triggers the reverser 132. In one embodiment, when the command CMD matches the RPMB protocol, the controller 131 changes the values stored in a reversion register (not shown). In one embodiment, the reversion register may be disposed in the controller 131, the reverser 132 or the volatile memory 133. In other embodiments, the reverser 132 may be integrated into the controller 131.

The reverser 132 determines whether to enter a reversion mode according to the value stored in the reversion register. For example, when the value stored in the reversion register is equal to a predetermined value, the reverser 132 enters the reversion mode. During the reversion mode, the reverser 132 reverses the arranged sequence of the arrangement of the values of input data to generate output data. When the value stored in the reversion register does not equal to the predetermined value, the reverser 132 exits the reversion mode and does not reverse the sequence of the arrangement of the values of the input data.

The invention does not limit which element provides the input data. When the command CMD is a write command, the input data is provided from the host device 110. In this case, the output data provided from the reverser 132 may be stored in the non-volatile memory 122 or the volatile memory 133. In one embodiment, the non-volatile memory 122 has a specific area to store the output data generated from the reverser 132. When the command CMD is a read command, the input data is provided from the non-volatile memory 122. In this case, the output data generated from the reverser 132 is directly provided to the host device 110 or first stored in the volatile memory 133 and then output to the host device 110.

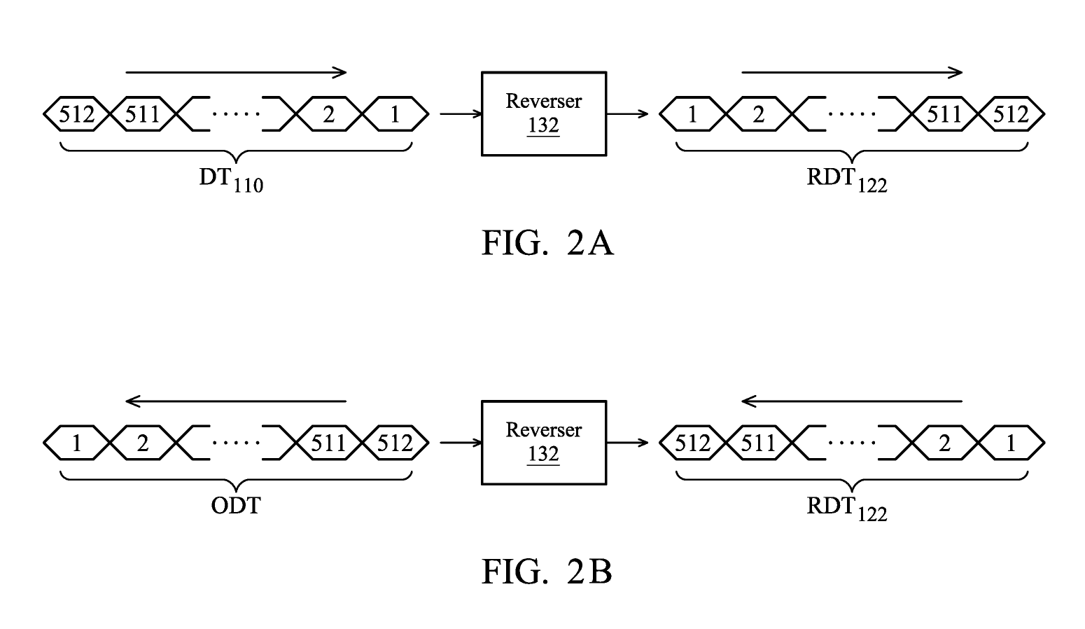

FIG. 2A shows the relationship between input data and output data, according to various aspects of the present disclosure. Assume that the command CMD is a write command and matches the RPMB protocol. In such cases, the host device 110 provides external data DT₁₁₀ to the storage device 120. As shown in FIG. 2A, the external data DT₁₁₀ comprises bytes 1˜512. The host device 110 sequentially outputs the bytes 1˜512, wherein the host device 110 first outputs the byte 1 and finally outputs the byte 512.

The reverser 132 sequentially receives the bytes 1˜512 of the external data DT₁₁₀. In other words, the reverser 132 first receives the byte 1 and then receives the byte 2 and finally receives the byte 512. In this embodiment, the reverser 132 reverses the sequence of the arrangement of the bytes 1˜512 of the external data DT₁₁₁₀ (referred to as the input data) to generate reversed data RDT₁₂₂ (referred to as the output data). The reverser 132 stores the reversed data RDT₁₂₂ into the non-volatile memory 122 or the volatile memory 133. As shown in FIG. 2A, the reverser 132 first outputs the byte 512, then the byte 511 and finally the byte 1. In this embodiment, the reverser 132 changes the sequence of the bytes of the external data DT₁₁₀ to generate the reversed data RDT₁₂₂ according to a first in last out (FIFO) method. Therefore, the sequence of the arrangement of the bytes of the reversed data RDT₁₂₂ is opposite to the sequence of the arrangement of the bytes of the external data DT₁₁₀.

FIG. 2B shows another relationship between input data and output data, according to various aspects of the present disclosure. Assume that the command CMD matches the RPMB protocol and is a read command to read the reversed data RDT₁₂₂ previously stored in the non-volatile memory 122. In this case, the reversed data RDT₁₂₂ is served as input data. The reverser 132 first reads the byte 512 of the reversed data RDT₁₂₂, then reads the byte 511 of the reversed data RDT₁₂₂ and finally reads the byte 1 of the reversed data RDT₁₂₂.

The reverser 132 reverses the sequence of the values of the reversed data RDT₁₂₂ to generate output data ODT. As shown in FIG. 2B, the reverser 132 first outputs the byte 1, then the byte 2 and finally the byte 512. In this embodiment, the sequence of the bytes of the output data ODT is opposite to the sequence of the bytes of the reversed data RDT₁₂₂. In this embodiment, the reverser 132 processes the sequence of the bytes of the reversed data RDT₁₂₂ to generate the output data ODT according to a FIFO method.

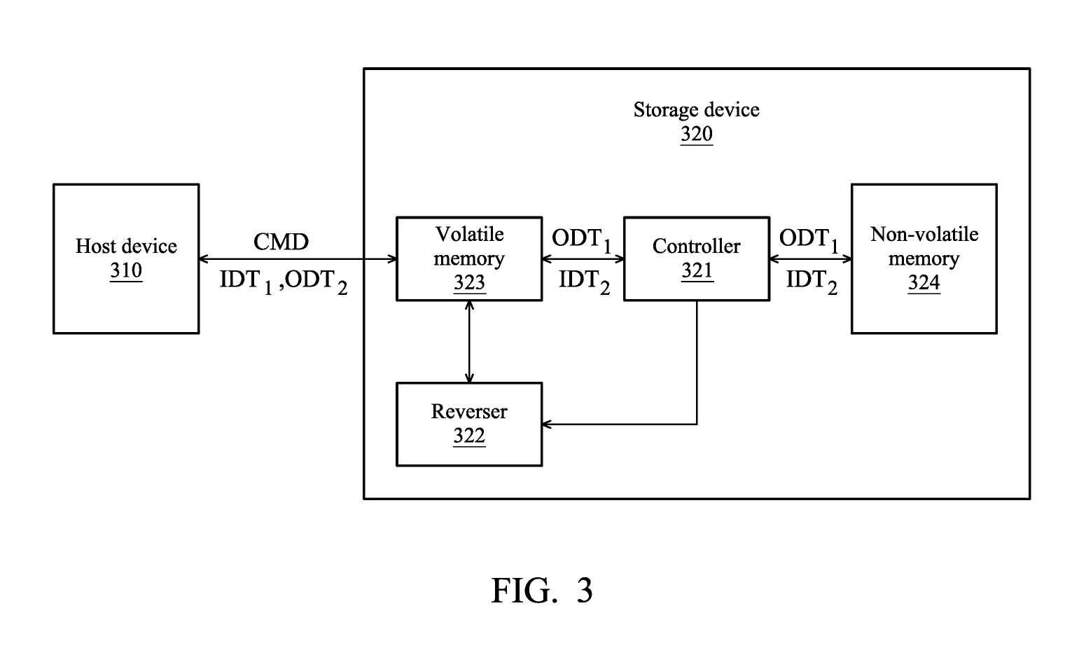

FIG. 3 is a schematic diagram of an exemplary embodiment of a storage device, according to various aspects of the present disclosure. When a host device 310 provides a command CMD, the volatile memory 323 stores the command CMD. The controller 321 or the reverser 322 determines the type of the command CMD and determines whether the command CMD matches the RPMB protocol according to the command CMD stored in the volatile memory 323. In another embodiment, the controller 321 or the reverser 322 directly receives the command CMD to determine the type of the command CMD and determine whether the command CMD matches the RPMB protocol.

When the command CMD is a write command, the controller 321 operates in a write mode. In the write mode, the storage device 320 receives input data IDT₁ provided from the host device 310. In this embodiment, the volatile memory 323 stores the input data IDT₁. When the controller 321 or the reverser 322 determines that the command CMD does not match the RPMB protocol, the controller 321 reads the volatile memory 323 and writes the input data IDT₁ into the non-volatile memory 324. However, when the controller 321 or the reverser 322 determines that the command CMD matches the RPMB protocol, the reverser 322 reverses the sequence of the arrangement of the values of the input data IDT₁ to generate output data ODT₁.

In this embodiment, the reverser 322 stores the output data ODT₁ to the volatile memory 323. The controller 321 reads the volatile memory 323 to retrieve the output data ODT₁ and stores the output data ODT₁ to the non-volatile memory 324. In this case, the sequence of the arrangement of the values of the output data ODT₁ is opposite from the sequence of the arrangement of the values of the input data IDT₁. In another embodiment, the reverser 322 does not store the output data ODT₁ to the volatile memory 323. In this case, the reverser 322 directly provides the output data ODT₁ to the controller 321. In such cases, the controller 321 stores the output data ODT₁ provided from the reverser 322 to the volatile memory 323. The controller 321 reads the volatile memory 323 to retrieve the output data ODT₁ and then transmits the output data ODT₁ retrieved from the volatile memory 323 to the non-volatile memory 324. In some embodiment, the controller 321 directly stores the output data ODT₁ provided from the reverser 322 to the non-volatile memory 324. In this case, the controller 321 does not store the output data ODT₁ provided from the reverser 322 to the volatile memory 323.

When the command CMD is a read command, the controller 321 operates in a read mode. In the read mode, the controller 321 reads the non-volatile memory 324 to retrieve input data IDT₂ and stores the input data IDT₂ retrieved from the non-volatile memory 324 to the volatile memory 323. When the command CMD does not match the RPMB protocol, the controller 321 reads the volatile memory 323 to provide the input data IDT₂ to the host device 310.

However, when the command CMD does not match the RPMB protocol, the reverser 322 reverses the sequence of the arrangement of the values of the input data IDT₂ to generate output data output data ODT₂. In one embodiment, the sequence of the arrangement of the values of the input data IDT₂ is the same as the sequence of the arrangement of the values of the output data ODT₁. In this embodiment, the reverser 322 stores the output data ODT₂ to the volatile memory 323. The controller 321 reads the volatile memory 323 to retrieve the output data ODT₂ and provides the retrieved output data ODT₂ to the host device 310. The sequence of the arrangement of the values of the output data ODT₂ is opposite to the sequence of the arrangement of the values of the input data IDT₂. In another embodiment, the reverser 322 directly provides the output data ODT₂ to the host device 310.

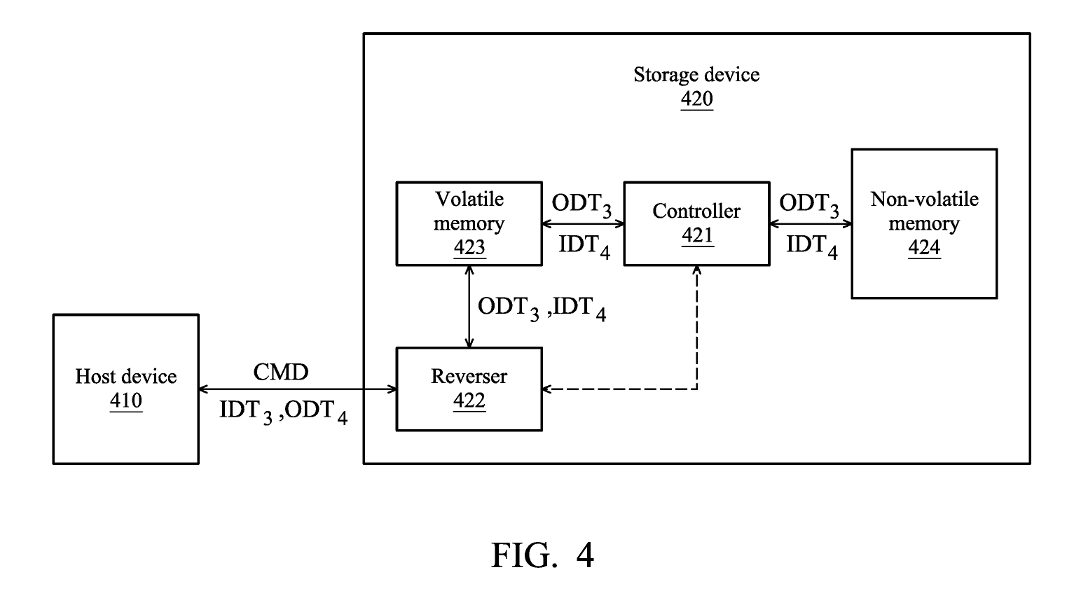

FIG. 4 is a schematic diagram of another exemplary embodiment of the storage device, according to various aspects of the present disclosure. In this embodiment, when the host device 410 provides a command CMD, the reverser 422 receives the command CMD. The reverser 422 determines the type of the command CMD and determines whether the command CMD matches a RPMB protocol. In another embodiment, the reverser 422 stores the command CMD to the volatile memory 423. In this case, the controller 421 or the reverser 422 determines the type of the command CMD and determines whether the command CMD matches a RPMB protocol. In one embodiment, the controller 421 determines the type of the command CMD and the reverser 422 determines whether the command CMD matches a RPMB protocol. In other embodiments, the controller 421 directly receives the command CMD to determine the type of the command CMD and determine whether the command CMD matches a RPMB protocol.

When the command CMD is a write command, the controller 421 operates in a write mode. In the write mode, the host device 410 provides input data IDT₃. In one embodiment, when the command CMD does not match the RPMB protocol, the reverser 422 directly stores the input data IDT₃ to the volatile memory 423. In this case, the controller 421 reads the volatile memory 423 to retrieve the input data IDT₃ and transmits the retrieved input data IDT₃ to the non-volatile memory 424.

However, when the command CMD matches the RPMB protocol, the reverser 422 reverses the sequence of the arrangement of the values of the input data IDT₃ to generate output data ODT₃. In one embodiment, the reverser 422 first stores the input data IDT₃ to the volatile memory 423, then reads the volatile memory 423 to retrieve the input data IDT₃ and then reverses the sequence of the arrangement of the values of the input data IDT₃ to generate the output data ODT₃. Next, the reverser 422 stores the output data ODT₃ to the volatile memory 423. In one embodiment, the output data ODT₃ replaces the input data IDT₃ previously stored in the volatile memory 423, but the disclosure is not limited thereto. The controller 412 reads the volatile memory 423 to retrieve the output data ODT₃ and then stores the output data ODT₃ retrieved from the volatile memory 423 to the non-volatile memory 424. In this case, the sequence of the arrangement of the values of the output data ODT₃ is inversed to the sequence of the arrangement of the values of the input data IDT₃. In another embodiment, the controller 421 may directly store the output data ODT₃ to the non-volatile memory 424. In some embodiments, the controller 421 first store the output data ODT₃ to the volatile memory 423, then read the volatile memory 423 to retrieve the output data ODT₃ and then stores the retrieved output data ODT₃ to the non-volatile memory 424.

When the command CMD is a read command, the controller 421 operates in a read mode. In the read mode, the controller 421 reads input data IDT₄ provided from the non-volatile memory 424 and stores the input data IDT₄ to the volatile memory 423. When the command CMD does not match the RPMB protocol, the controller 421 directly outputs the input data IDT₄ stored in the volatile memory 423 to the host device 410. However, when the command CMD matches the RPMB protocol, the reverser 422 reverses the sequence of the arrangement of the values of the input data IDT₄ stored in the volatile memory 423 to generate output data ODT₄. In one embodiment, the input data IDT₄ is the output data ODT₃.

In this embodiment, the reverser 422 directly outputs the output data ODT₄ to the host device 410. The sequence of the arrangement of the values of the output data ODT₄ is opposite to the sequence of the arrangement of the values of the input data IDT₄. In another embodiment, the reverser 422 stores the output data ODT₄ to the volatile memory 423. The controller 421 reads the output data ODT₄ stored in the volatile memory 423 and then transmits the output data ODT₄ to the host device 410.

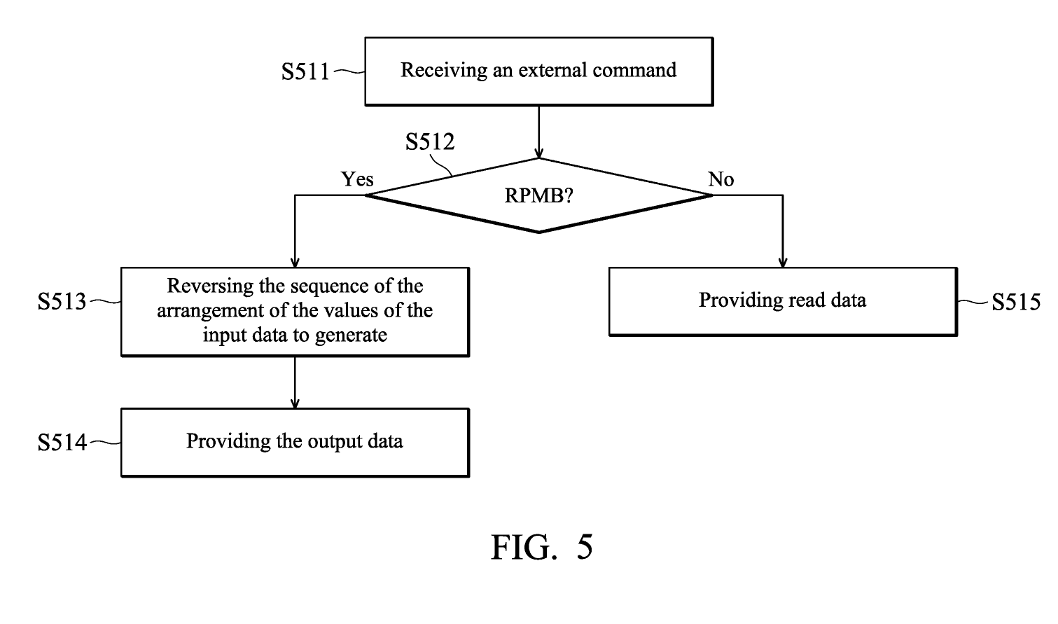

FIG. 5 is a flowchart diagram of an exemplary embodiment of a control method, according to various aspects of the present disclosure. The control method is applied in a storage device. In one embodiment, the storage device is coupled to a host device. First, an external command is received (step S511). In one embodiment, the external command is provided from the host device.

A determination is made as to whether the external command matches a RPMB protocol (step S512). In one embodiment, the storage device comprises a controller to determine whether the external command matches the RPMB protocol. When the external command does not match the RPMB protocol, read data is provided to the host device or input data is stored according to the type of the external command (step S515). In one embodiment, the controller disposed in the storage device determines whether the external command is a write command or a read command. When the external command is the write command, the controller writes input data provided from the host device to a non-volatile memory. When the external command is a read command, the controller reads the non-volatile memory to generate read data and outputs the read data to the host device.

When the external command matches the RPMB protocol, the sequence of the arrangement of the values of the input data is reversed to generate output data (step S513). In one embodiment, when the external command matches the RPMB protocol, the controller of the storage device activates a reverser to reverse the sequence of the arrangement of the values of the input data to generate output data.

The invention does not limit how the controller activates the reverser. In one embodiment, when the external command matches the RPMB protocol, the controller changes the value stored in a reversion register. The reverser determines whether the value stored in the reversion register is equal to a predetermined value. When the value stored in the reversion register is equal to the predetermined value, the reverser reverses the sequence of the arrangement of the values of the input data. When the value stored in the reversion register is not equal to the predetermined value, the reverser does not reverse the sequence of the arrangement of the values of the input data. In one embodiment, the reversion register is disposed in the controller or in the reverser. In another embodiment, the reverser generates the output data according to a FIFO method. Additionally, the source which provides the input data is not limited in the present disclosure. In one embodiment, the input data is provided from a host device. The host device is disposed outside of the storage device. In another embodiment, the input data is previously stored in the storage device.

Next, the output data is provided to the host device or the output data is stored (step S514). In one embodiment, when the input data is provided from the host device, the storage device stores the output data. In this case, the input data provided from the host device may be stored in a volatile memory disposed in the storage device. The reverser disposed in the storage device reads the input data stored in the volatile memory and reverses the sequence of the arrangement of the values of the input data. In one embodiment, the output data generated from the reverser is also stored in the volatile memory. In this case, a controller disposed in the storage device reads the output data stored in the volatile memory and then transmits the output data to an non-volatile memory. In another embodiment, the output data generated from the reverser is directly stored in an non-volatile memory disposed in the storage device. In this case, the output data is not stored in the volatile memory disposed in the storage device.

However, when the input data is provided from an non-volatile memory disposed in the storage device, the storage device outputs the output data to the host device. In one embodiment, the input data provided from the non-volatile memory is first loaded to the volatile memory. At this time, the reverser reads the input data stored in the volatile memory and reverses the sequence of the arrangement of the values of the input data to generate the output data. In one embodiment, the controller or the reverser may store the output data to the volatile memory. Then, the controller or the reverser transmits the output data stored in the volatile memory to the host device. In another embodiment, the controller or the reverser directly provides the output data to the host device. In this case, the output data is not stored in the volatile memory.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A storage device coupled to a host device, comprising:
a volatile memory;
a non-volatile memory;
a controller accessing the volatile memory and the non-volatile memory; and
a reverser reversing a sequence of an arrangement of values of input data to generate output data, wherein the controller provides the output data to the host device or stores the output data in the non-volatile memory.

2. The storage device as claimed in claim 1, wherein during a write mode, the host device provides the input data.

3. The storage device as claimed in claim 2, wherein during the write mode, the volatile memory stores the input data, the reverser reverses the sequence of the arrangement of the values of the input data stored in the volatile memory to generate the output data, the reverser stores the output data in the volatile memory, and the controller reads the output data stored in the volatile memory to generate read data and then stores the read data in the non-volatile memory.

4. The storage device as claimed in claim 2, wherein during the write mode, the reverser receives and reverses the sequence of the arrangement of the values of the input data to generate the output data and the volatile memory stores the output data.

5. The storage device as claimed in claim 1, wherein during a read mode, the non-volatile memory provides the input data.

6. The storage device as claimed in claim 5, wherein during the read mode, the controller stores the input data in the volatile memory, the reverser reverses the sequence of the arrangement of the values of the input data stored in the volatile memory to generate the output data, the reverser stores the output data in the volatile memory, and the controller reads the output data stored in the volatile memory to generate read data and then provides the read data to the host device.

7. The storage device as claimed in claim 5, wherein during the read mode, the controller stores the input data in the volatile memory, and the reverser reverses the sequence of the arrangement of the values of the input data stored in the volatile memory and then provides the output data to the host device.

8. The storage device as claimed in claim 1, further comprising:
a reversion register storing a value, wherein when the host device provides a specific command to the storage device, the controller changes the value stored in the reversion register,
wherein when the value stored in the reversion register is equal to a predetermined value, the reverser reverses the sequence of the arrangement of the values of the input data, and when the value stored in the reversion register is not equal to the predetermined value, the reverser does not reverse the sequence of the arrangement of the values of the input data.

9. The storage device as claimed in claim 8, wherein the specific command matches a replay protected memory block (RPMB) protocol.

10. The storage device as claimed in claim 1, wherein the reverser is integrated into the controller.

11. A control method for a storage device, comprising:
receiving an external command;
determining a type of the external command;
reversing a sequence of an arrangement of values of input data to generate output data when the external command matches a specific protocol; and
providing the output data to a host device or storing the output data.

12. The control method as claimed in claim 11, wherein when the input data is provided from the host device, the output data is stored.

13. The control method as claimed in claim 12, further comprising:
storing the input data in a volatile memory, wherein the output data is stored in the volatile memory; and
reading the output data stored in the volatile memory and then storing the output data in a non-volatile memory.

14. The control method as claimed in claim 12, further comprising:
storing the input data in a volatile memory;
reading the input data stored in the volatile memory to reverse the sequence of the arrangement of the values of the input data; and
storing the output data in a non-volatile memory.

15. The control method as claimed in claim 11, wherein when the input data is provided from a non-volatile memory disposed in the storage device, the output data is provided to the host device.

16. The control method as claimed in claim 15, further comprising:
storing then input data in a volatile memory;
reading the input data stored in the volatile memory to reverse the sequence of the arrangement of the values of the input data;
storing the output data in the volatile memory; and
reading the output data stored in the volatile memory to provide the output data to the host device.

17. The control method as claimed in claim 15, further comprising:
storing the input data in the volatile memory; and
reading the input data stored in the volatile memory to reverse the sequence of the arrangement of the values of the input data, wherein the output data is provided to the host device.

18. The control method as claimed in claim 11, further comprising:
changing a value stored in a reversion register when the external command matches the specific protocol; and
determining whether the value stored in the reversion register is equal to a predetermined value
wherein the sequence of the arrangement of the values of the input data is reversed when the value stored in the reversion register is equal to the predetermined value, and the sequence of the arrangement of the values of the input data is not reversed when the value stored in the reversion register is not equal to the predetermined value.

19. The control method as claimed in claim 18, wherein the step of determining the type of the external command is to determine whether the external command matches a replay protected memory block (RPMB) protocol.

20. An accessing system comprising:
a host device providing an external command; and
a storage device receiving the external command and comprising:
a volatile memory;
a non-volatile memory;
a controller accessing the volatile memory and the non-volatile memory; and
a reverser reversing a sequence of an arrangement of values of input data to generate output data, wherein the controller outputs the output data to the host device or stores the output data in the non-volatile memory.
